(19) United States
(12) Patent Application Publication
(10) Pub. No.: US 2014/0222271 A1
(43) Pub. Date: Aug. 7, 2014

(54) AUTONOMOUS MOBILE ROBOT INDUCTIVE CHARGING SYSTEM

(71) Applicant: MetraLabs Automation, Inc., Del Mar, CA (US)

(72) Inventors: Matthias Merten, San Diego, CA (US); Christian Martin, Kassel (DE); Andreas Bley, Ilmenau (GE)

(73) Assignee: MetraLabs Automation, Inc., Del Mar, CA (US)

(21) Appl. No.: 14/175,869

(22) Filed: Feb. 7, 2014

Related U.S. Application Data
(60) Provisional application No. 61/762,220, filed on Feb. 7, 2013.

(51) Int. Cl. H02J 7/02

(52) U.S. Cl. CPC H02J 7/025
USPC 701/22

(57) ABSTRACT

Systems and method for inductive charging of autonomous mobile robots are provided. The systems and methods increase safety and reduce contaminants such as metal particles in a clean room environment reduce impurities in charging that increase the transfer resistance during charging.

### BACKGROUND

1. Field of the Invention

The present invention is generally related to mobile robots and more particularly related to an inductive charging system in an autonomous mobile robot.

2. Related Art

The energy storage of conventional mobile robots (e.g. batteries or super-capacitors) needs to be recharges at certain times. Therefore, the robot is manually plugged into a stationary charger or an electrical socket to charge.

Current autonomous mobile robots transfer electrical energy for the recharging of the energy storage by the usage of metal contacts conduction electrical energy. The realizations are based on a combination of a jack and a plug, or by current collectors connected to electrical plates. Three main drawbacks can be identified by the existing approaches based on electrical contacts:

To ensure high user safeness, contacts providing high voltage levels need to be designed in a way that a user cannot get access to these metal parts. This increases the complexity of the design of the charging systems. An alternative approach would be the usage of extra-low voltages that are safe for users; however, the usage of lover voltage levels leads to an increased charging time or to a higher stress of current-carrying components, because of the higher current to be transferred.

Another drawback of contact based charging systems is an increase of the transfer resistance between the charging station and the robot, e.g., by corrosion, abrasion, or contamination of the contacts. In this case, the power-loss increases leading to a slower charging process and the generation of heat. A further increase of the transfer resistance could lead to a mal-function of the charging station or even damage on the charging station or the robot by overheating.

The third disadvantage of contact-based charging systems is the generation of metallic particles that will be produced as soon as the robot docks its charging contacts onto the charging contacts/plats of the charging station. Even if in most applications, this effect is negligible, it is relevant, for example, in the usage in clean-rooms.

Therefore, what is needed is a system and method that overcomes these significant problems found in the conventional systems as described above.

### SUMMARY

Accordingly, describe herein are systems and method for inductive charging of autonomous mobile robots. It allows for the realization of charging systems without accessible metal plates for the transfer of charging power between a charging station and a mobile robot system. Therefore, this system provides a high safeness for humans (no accessible voltage levels), a higher robustness against impurity (e.g., chemical substances that could increase the transfer resistance), and it does not release metal particles that contaminate the robot environment (important for the usage in the semiconductor industry).

Other features and advantages of the present invention will become more readily apparent to those of ordinary skill in the art after reviewing the following detailed description and accompanying drawings.

### BRIEF DESCRIPTION OF THE DRAWINGS

The structure and operation of the present invention will be understood from a review of the following detailed description and the accompanying drawings in which like reference numerals refer to like parts and in which:

FIG. 1 is a block diagram illustrating an example autonomous mobile robot and a charging station with horizontally oriented coils according to an embodiment of the invention;

FIG. 2 is a block diagram illustrating an example configuration of required components of an autonomous mobile robot according to an embodiment of the invention;

FIG. 3 is a block diagram illustrating an example system configuration with required components to transfer inductive energy from a charging station to a robot charger according to an embodiment of the invention; and

FIG. 4 is a flow diagram illustrating an example process for the control of an autonomous mobile robot with a particular focus on the charging process according to an embodiment of the invention; and

FIG. 5 is a flow diagram illustrating an example process for the control of the power stage output of the charging station according to an embodiment of the invention; and

FIG. 6 is a flow diagram illustrating an example process for the control of the charging process of a robot charger according to an embodiment of the invention; and

FIG. 7 is a block diagram illustrating an example wired or wireless processor enabled device that may be used in connection with various embodiments described herein.

### DETAILED DESCRIPTION

Certain embodiments disclosed herein provide for charging an autonomous mobile robot on a charging station without human direction based on the transfer of inductive energy. Therefore, the autonomous mobile robot is able to freely navigate in its environment, to detect and to approach the charging station and to be charged by the transfer of inductive energy generated by the charging station. For example, one method disclosed herein allows for determination of the position of the charging station to support the approaching process of the robot over the charging station and to optimize the transmission efficiency for the charging process. After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

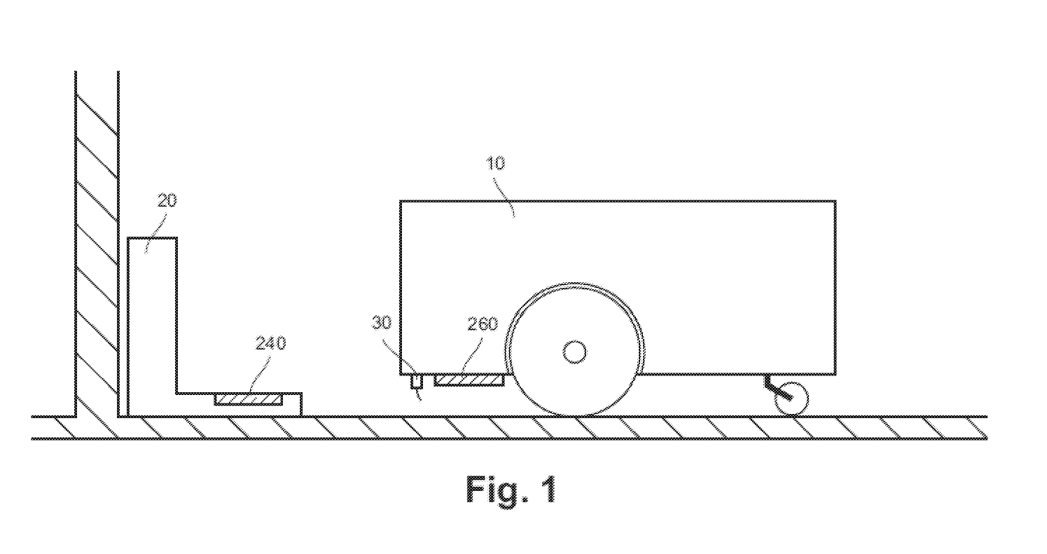

Referring to FIG. 1, the invention comprises an autonomous mobile robot 10 that can freely navigate in its environment. If the robot needs to be recharged, it can automatically drive to a charging station 20, which provides the necessary charging energy. The charging station is often placed on a wall or other fixed objects, so that it is out of the way of humans walking around. The power transmission between the charging station and the mobile robot is based on inductive transmission. Therefore, a primary coil 240 is integrated into the charging station to transmit inductive energy, and a secondary coil 260 is integrated into the mobile robot to receive inductive energy. The two coils can be mounted in a horizontal orientation (as shown) or in a vertical orientation or other orientation sufficient for inductive transmission. The horizontal orientation of the coils allows for a substantially constant distance between both coils during the charging process, which allows for substantially constant transmission characteristics. The disadvantage is that small metal parts could lie on the primary coil and could heat up during the charging process. To avoid this, the robot could be equipped with a cleaning brush 30, which cleans the surface of the primary coil when the robot drives over the charging station.

The present specification describes a charging system for an autonomous mobile robot. The components of such a mobile robot are shown in FIG. 2 in more detail: The robot contains a drive system 100 that enables the robot to move around in its operational area. This drive system is usually built from two or more driven wheels, one or more castor wheels, gear motors, and power electronics. The mobile robot is further equipped with sensors 110 to detect its environment. Such sensors can include tactile sensors, acoustic distance sensors, optical distance sensors, cameras and other sensors. These sensors are used to avoid collision, to localize the robot, and to find and approach to the charging station. The main processor 120 of the robot executes all software algorithms and controls the behavior of the robot. It can be built of one or more processors executing all software modules or multiple processors with segmented task execution. Data storage 130 is integrated to store user and operational information and executable software modules. The battery 140 supplies all electrical components of the robot and can be built from a single battery or multiple batteries. Instead of a battery, super capacitors could also be applied as energy storage. Finally, a robot charger 150 is integrated that monitors the status of the battery and that controls the charging process of the robot.

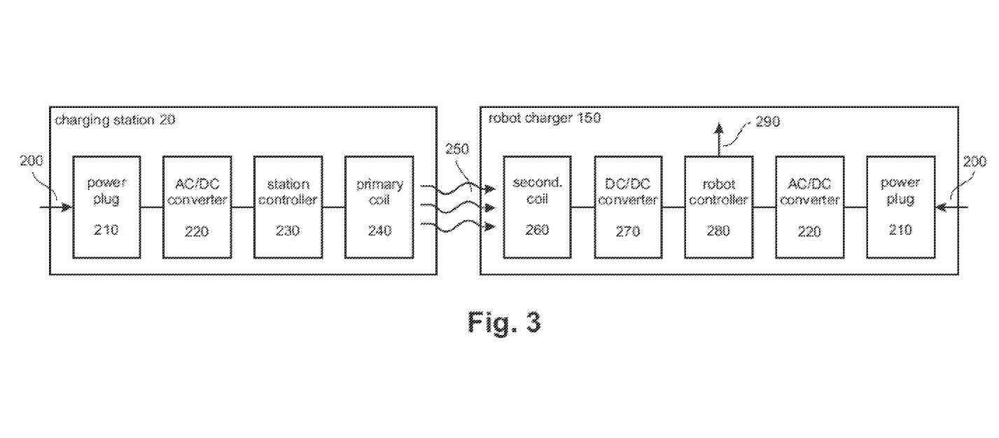

FIG. 3 shows all parts of the charging station as well as the robot charger that are necessary to realize an inductive charging system for mobile robot. The charging station is powered by line voltage 200 that is connected to the charging station by the power plug 210. The connected AC/DC-converter 220 converts the line voltage into a direct current (DC) voltage. To be able to charge the robot manually, these three components can also be integrated into the robot, which allows recharging the battery without the usage of the charging station. The station controller 230 of the charging station uses the DC voltage from the AC/DC-converter to control the primary coil 240 of the charging station. The inductive energy 250 generated by the primary coil is transferred to the secondary coil 260. The resulting output voltage of the secondary coil is commutated and converted by the following DC/DC-converter 270. This converter generates a voltage level that can be used by the robot controller 280 to charge the batteries or to supply power to other components inside the robot system 290.

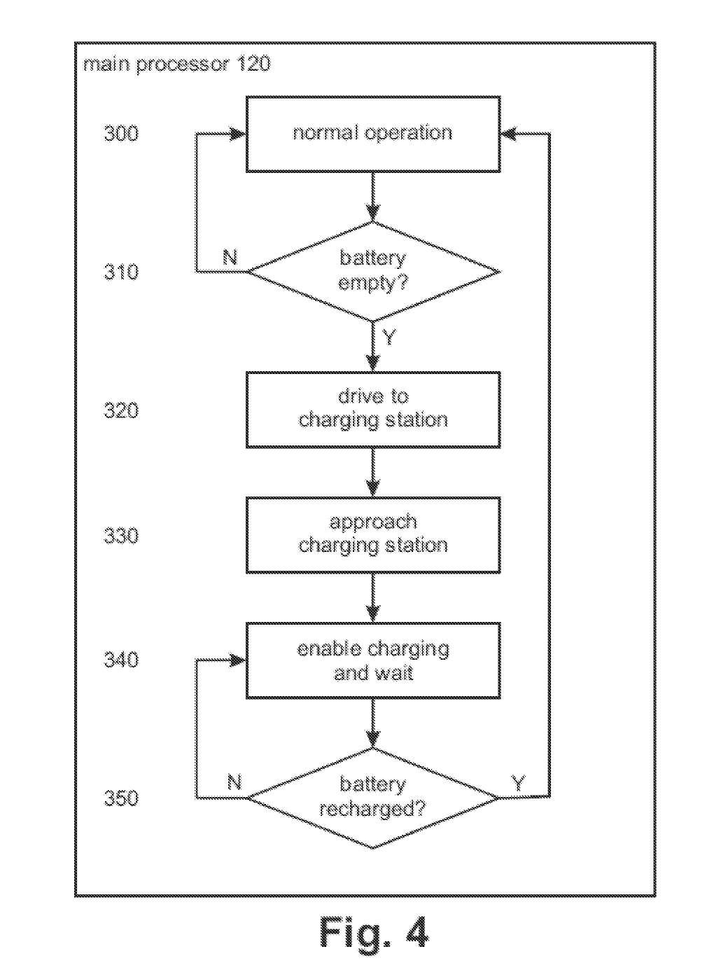

Referring to FIG. 4, the main processor is operating the mobile robot in its normal operation mode 300 as long as the batteries are not empty. This normal operation mode could include task execution, interaction with users, obstacle avoidance, localization, or path planning, just to name a few. Within the normal operation mode, the main processor monitors the battery state 310 and continues as long as the battery is sufficiently charged. If the battery is not sufficiently charged, the processor leaves its normal operation mode and starts driving to the charging station 320 using its map of the environment and the knowledge about the position of the charging station within its environment and/or real time sensor information. If multiple charging stations are present, the robot can choose the charging station closest to its current position. While driving to the charging station, the robot still avoids any collision with obstacles. After the robot arrives at the charging station, it approaches the charging station 330. This procedure is executed to position the secondary coil of the mobile robot substantially adjacent to the primary coil of the charging station within a defined accuracy range to optimize efficiency of the charging process. Depending on the orientation of the coils (horizontal or vertical), the procedure optimizes the lateral shift in two dimension (horizontal) or the lateral shift in one dimension as well as the distance between both coils (vertical). The third dimension may be constant based on the mechanical construction of the mobile robot and the charging station. To approach the charging station and to position the secondary coil substantially adjacent to the primary coil, the mobile robot can use different kind of strategies. One example is the usage of distance sensors, like laser range finders or sonar sensors, to generate an impression of its environment (sensor image). The mobile robot compares the sensor image to a template that represents the sensor image in the final position over the charging station. Based on the differences of the current sensor image and the template, the mobile robot calculates its position relative to the charging station and executes drive commands to approach the charging station. The comparison of the sensor image to the template and the calculation of drive commands are executed constantly to achieve the highest positioning accuracy. Another approach would be the usage of electromagnetic sensors to detect the electromagnetic field generated by the primary coil of the charging station. In this case, the mobile robot uses the information of these sensors to estimate the position of the primary coil relative to the robot and also executes drive commands to minimize inaccuracy. It is further possible to use the voltage level induced by the primary coil into the secondary coil to evaluate whether the charging coil of the robot is positioned substantially adjacent to the charging coil of the charging station within the required accuracy range. The dimensioning of the transfer characteristics of the charging system advantageously considers inaccuracies of the robot based on inaccuracies of the sensors or the driving behavior. For example in a horizontal orientation of the coils, a lateral tolerances between both coils of about two centimeter would allow for the usage of low-cost sensors and a faster approach of the charging station. After the mobile robot approached at its final charging position, the main processor enables the charging process 340 by enabling the robot charger to use the energy received by the secondary coil to charge the battery. The robot will control the charging state of the battery 350 and will continue the charging process as long as the battery is not recharged or a trigger event to stop charging occurred. As soon as the battery is fully charged (or a trigger event occurred) the main processor will go back into normal operation and continues its other tasks.

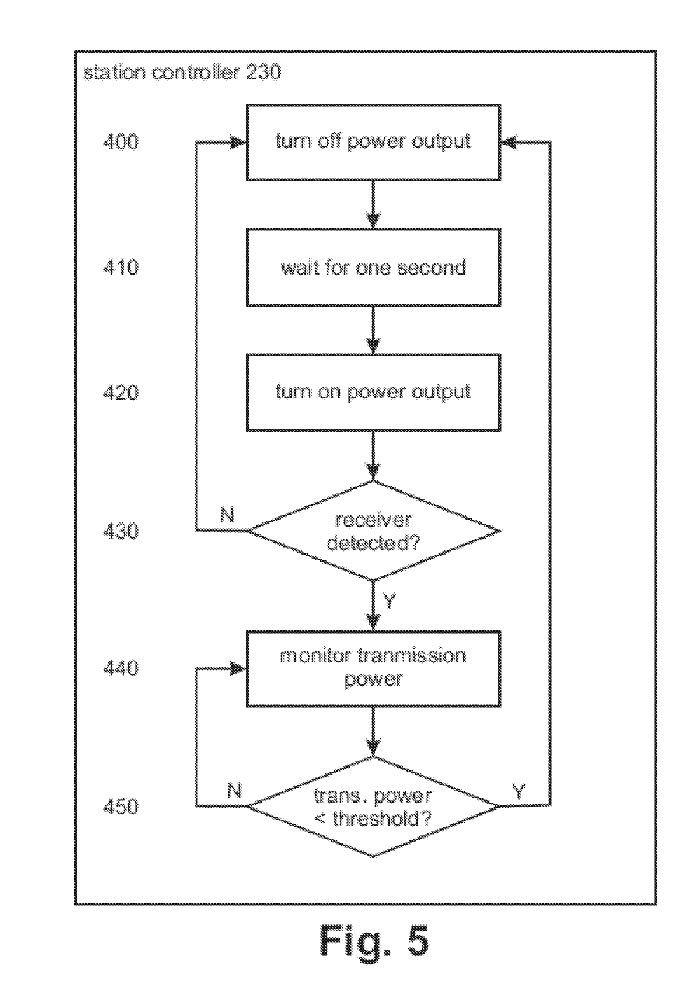

The charging station contains the station controller that is responsible for the control of the energy emitted by the primary coil. The functionality of this station controller is shown in FIG. 5. The default state of this processor is that the power output for the primary coil is turned off 400. The station controller waits a given time (e.g. one second) 410 before it turns on the power output of the primary coil 420. This allows the station controller to detect whether a receiver is taking energy from the electromagnetic field generated by the primary coil 430. If this is not the case, the station controller goes back into the initial state and turns off the power output. In the case that the station controller detects a deformation of the electromagnetic field, meaning that a receiver is taking energy, the station controller will keep the power output activated and continues to the next state. In this state, the station controller monitors the power transmitted by the primary coil 440. If the transmitted power is higher than a defined threshold, this means that the receiver is still present and the station controller continues monitoring the power output level. If the power drops under the threshold, the station controller assumes that the receiver is no longer present and moves back to the initial state turning off the power output. In an alternative embodiment, the presence of the robot may be sensed by the charging station and trigger power output of the primary coil 420. Alternatively, the robot may send a signal to the charging station to trigger power output of the primary coil 420.

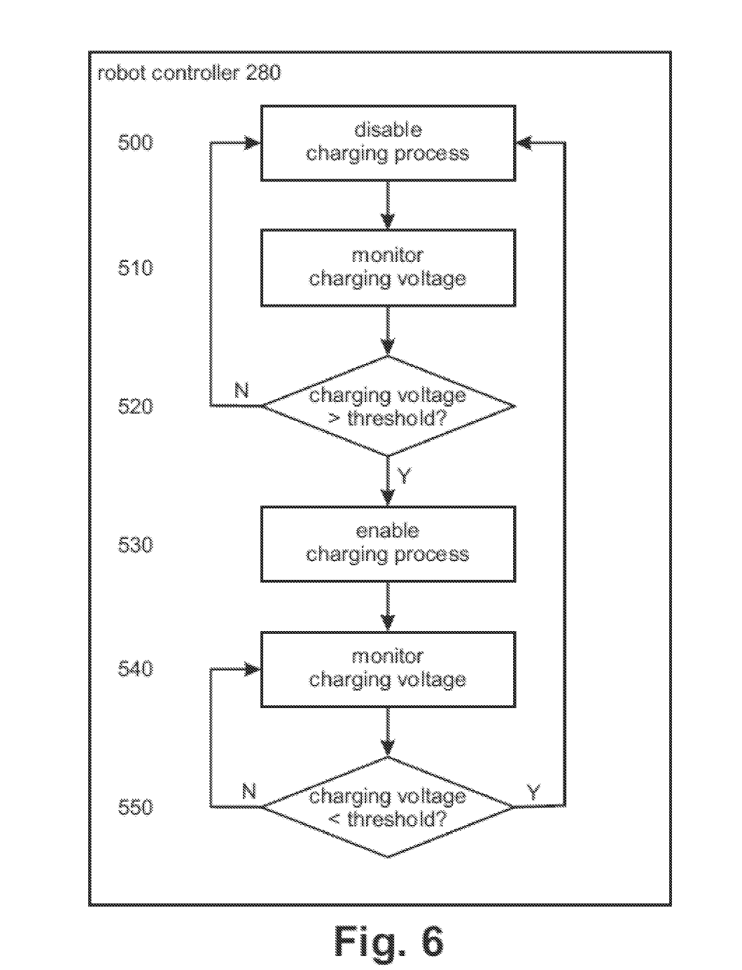

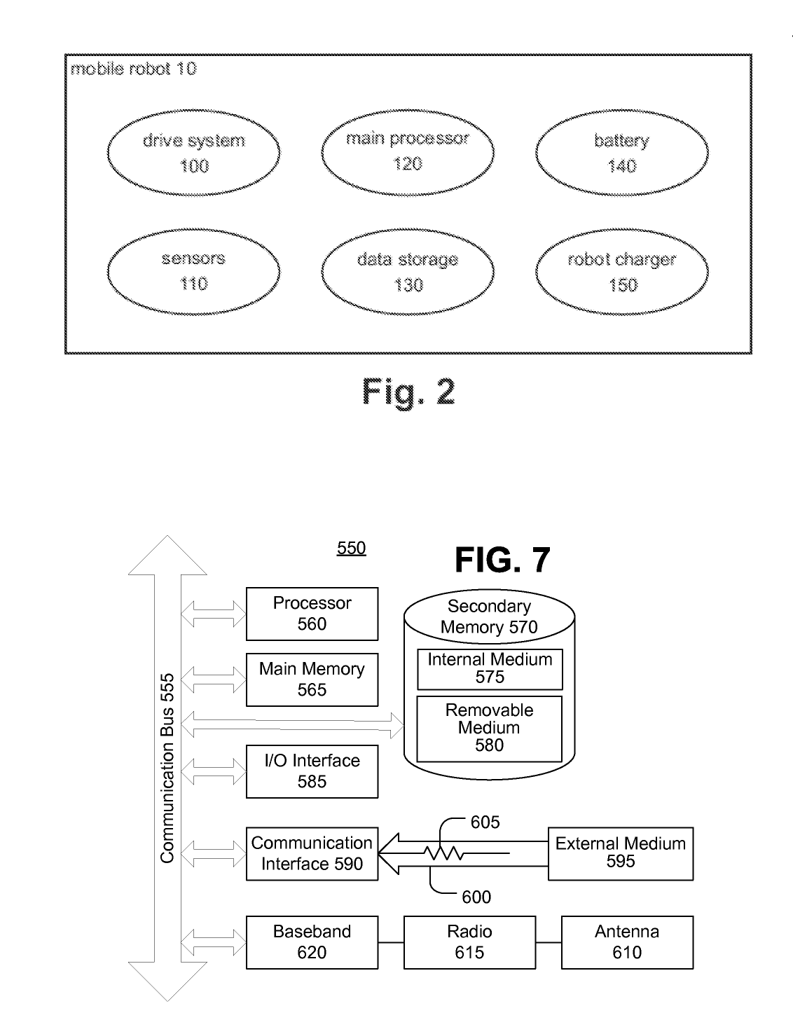

Similar to the station controller, the robot controller of the mobile robot, shown in FIG. 6 is in a default state with a disabled charging process 500. The robot controller monitors the charging voltage 510 that is generated by the DC/DC-converter connected to the secondary coil. The robot controller checks the voltage 520 to determine whether a charging system is inducing energy into the robot system, e.g., if a charging voltage value exceeds a threshold. If this is not the case, the robot will keep the charging process disabled. If the voltage level rises over a threshold, the robot controller assumes that the charging station is present and enables the charging process 530. Similar to the station controller, the robot controller monitors the charging voltage 540 and compares it to a threshold 545. As long as the charging voltage is higher than the threshold, the charging process continues. As soon as the charging voltage drops under the threshold, the robot controller goes back to the initial state and disables the charging process.

FIG. 7 is a block diagram illustrating an example wired or wireless system 550 that may be used in connection with various embodiments described herein. For example the system 550 may be used as or in conjunction with an autonomous mobile robot as previously described with respect to FIGS. The system 550 can be a conventional personal computer, computer server, personal digital assistant, smart phone, tablet computer, or any other processor enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

System 550 preferably includes a main memory 565 and may also include a secondary memory 570. The main memory 565 provides storage of instructions and data for programs executing on the processor 560. The main memory 565 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 570 may optionally include a internal memory 575 and/or a removable medium 580, for example a floppy disk drive, a magnetic tape drive, a compact disc (“CD”) drive, a digital versatile disc (“DVD”) drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 570. Examples of external storage medium 595 may include an external hard disk drive or an external optical drive, or and external magneto-optical drive.

Other examples of secondary memory 570 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage media 580 and communication interface 590, which allow software and data to be transferred from an external medium 595 to the system 550.

System 550 may also include an input/output (“I/O”) interface 585. The I/O interface 585 facilitates input from and output to external devices. For example the I/O interface 585 may receive input from a keyboard or mouse and may provide output to a display. The I/O interface 585 is capable of facilitating input from and output to various alternative types of human interface and machine interface devices alike.

System 550 may also include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a modem, a network interface card (“NIC”), a wireless data card, a communications port, a PCMCIA slot and card, an infrared interface, and an IEEE 1394 fire-wire, just to name a few.

Communication interface 590 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

The system 550 also includes optional wireless communication components that facilitate wireless communication over a voice and over a data network. The wireless communication components comprise an antenna system 610, a radio system 615 and a baseband system 620. In the system 550, radio frequency (“RF”) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown) that are executable by processor 560.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

1. An autonomous mobile robot, comprising:
a battery configured to power the autonomous mobile robot;
a drive system configured to move the autonomous mobile robot;
a charging system comprising a secondary coil and configured to charge the battery of the autonomous mobile robot;
a non-transitory computer readable medium configured to store executable programmed modules;
a processor communicatively coupled with the non-transitory computer readable medium configured to execute programmed modules stored therein;
a charging module stored in the non-transitory computer readable medium and configured to be executed by the processor, the charging module configured to
determine when a charge level of the battery is sufficiently low,
instruct the drive system to approach a charging station comprising a primary coil,
optimize the orientation of the secondary coil of the charging system to the primary coil of the charging station,
commence inductive charging between the charging system and the charging station,
monitor inductive charging between the charging system and the charging station, and
terminate charging based up a determination that the charge level of the batter is sufficiently full or based up a trigger event.

2. A computer implemented method for autonomous mobile robot inductive charging, where one or more processors are programmed to perform steps comprising:
determining when a charge level of a battery in the autonomous mobile robot is sufficiently low;
driving the autonomous mobile robot to approach a charging station;
optimizing the orientation of a secondary coil in the autonomous mobile robot to a primary coil in the charging station;
commencing inductive charging of the battery in the autonomous mobile robot from the charging station;
monitoring said inductive charging; and
terminating said inductive charging based upon a determination that the charge level of the battery is sufficiently full or based upon a trigger event.

3. A method for reducing metallic and non-metallic contaminations in a clean room environment, comprising:
operating an autonomous mobile robot in a clean room environment;
determining when a charge level of a battery in the autonomous mobile robot is sufficiently low;
driving the autonomous mobile robot to approach a charging station;
optimizing the orientation of a secondary coil in the autonomous mobile robot to a primary coil in the charging station;
commencing inductive charging of the battery in the autonomous mobile robot from the charging station;
monitoring said inductive charging; and
terminating said inductive charging based upon a determination that the charge level of the battery is sufficiently full or based upon a trigger event.
